(19) United States
(12) Patent Application Publication
(10) Pub. No.: US 2014/0282182 A1
(43) Pub. Date: Sep. 18, 2014

(54) MULTI-LAYERED VEHICLE DISPLAY SYSTEM AND METHOD

(71) Applicant: Hajime Yamada, (US)

(72) Inventor: Hajime Yamada, Rancho Palos Verdes, CA (US)

(73) Assignee: Honda Moror Co., Ltd., Tokyo (JP)

(21) Appl. No.: 13/834,507

(22) Filed: Mar. 15, 2013

(51) Int. Cl. G06F 3/0484

(52) U.S. Cl. CPC G06F 3/0484
USPC 715/771

(57) ABSTRACT

An interactive display system for use in a vehicle is provided. A first image source presents a first image to a vehicle occupant. A second image source presents a second image that appears to be positioned between the first image and the vehicle occupant. The first and second images form a graphical user interface (GUI) associated with a user application controlling a function of the vehicle. The first image source generates a first image including at least one graphical element associated with the graphical user interface (GUI) responsive to input from the vehicle occupant from at least one user input device. The second image source generates a second image as a cursor image responsive to input from the vehicle occupant via the at least one user input device, such that the vehicle occupant can interact with the at least one graphical element.

### BACKGROUND

The field of the disclosure relates generally to vehicles and, more particularly, to a multi-layered vehicle display system for interactive applications for use in vehicles.

Vehicles, such as automobiles, are being provided with increasingly sophisticated functions. At least some known vehicles include sophisticated information display systems for use by drivers and/or passengers. For example, at least some known automobiles include console displays that present a driver with critical driving information, such as speed, distance, fuel status, and/or vehicle operating condition status and warning indications. In addition known console displays can also present non-critical information, such as cabin temperature and fuel consumption rate. In addition, some vehicles include control systems, such as navigation, entertainment, and/or climate control systems that feature interactive applications that may be controlled by and are responsive to input from the driver or other vehicle occupants.

Therefore, vehicle information display systems are challenged to present an ever-increasing amount of complex information and interactive displays in a meaningful and organized way for easy access and use by a driver and/or passengers. Accordingly, it would be desirable to provide a vehicle display system that provides an interactive display, to a driver or other vehicle occupant in a more organized and more readily accessible manner than known display systems.

### BRIEF DESCRIPTION

In one embodiment, an interactive display system for use in a vehicle is provided. The system includes a computer system that includes at least one processor coupled to a memory device. The system includes a first image source communicatively coupled to the computer system, the first image source coupleable to the vehicle for presenting a first image to a vehicle occupant. The system also includes a second image source communicatively coupled to the computer system, the second image source coupleable to the vehicle for presenting a second image that appears to be positioned between the first image and the vehicle occupant, wherein the first and second images together comprise a graphical user interface (GUI) associated with a user application controlling an function of the vehicle. The system also includes at least one user input device coupled to the at least one processor. The memory device stores computer-executable instructions that, when executed by the at least one processor cause the at least one processor to cause the first image source to generate a first image comprising at least one graphical element associated with the graphical user interface (GUI), the at least one graphical element responsive to input from the vehicle occupant. The computer-executable instructions further cause the second image source to generate a second image comprising a cursor image responsive to input from the vehicle occupant via the at least one user input device, such that the vehicle occupant can interact with the at least one graphical element.

In another embodiment, a vehicle is provided that includes a console and a computer system coupleable to the console and including at least one processor coupled to a memory device. The vehicle includes a first image source communicatively coupled to the computer system for presenting a first image to a vehicle occupant. The vehicle also includes a second image source communicatively coupled to the computer system for presenting a second image that appears to be positioned between the first image and the vehicle occupant. The vehicle also includes at least one user input device coupled to the at least one processor. The memory device stores computer-executable instructions that, when executed by the at least one processor cause the at least one processor to cause the first image source to generate a first image associated with an function of the vehicle that is responsive to input by the vehicle occupant. The computer-executable instructions further cause the second image source to generate a cursor image responsive to input from the vehicle occupant via the at least one user input device, such that the vehicle occupant can interact with the at least one graphical element.

In yet another embodiment, a method for presenting an interactive display in a vehicle is provided, wherein the method is implemented using a computer system including at least one processor coupled to a memory device. The method includes presenting a first image to a vehicle occupant, using a first image source communicatively coupled to a vehicle, the first image comprising at least one graphical element. The method further includes presenting a second image to the vehicle occupant, using a second image source communicatively coupled to the vehicle, wherein the second image appears to be positioned between the first image and the vehicle occupant, the second image comprising a cursor image responsive to input received from the vehicle occupant via at least one user input device coupled to the at least one processor, and wherein the first and second images together comprise a graphical user interface (GUI) associated with a user application controlling a function of the vehicle. The method further includes receiving input from the vehicle occupant via the at least one user input device such that the vehicle occupant can interact with the at least one graphical element.

### BRIEF DESCRIPTION OF THE DRAWINGS

FIG. 1 is a perspective view of an exemplary console area of a vehicle, for use with an exemplary display system.

FIG. 2 is a schematic illustration of an exemplary display system that may be used with the vehicle shown in FIG. 1.

FIG. 3 is a schematic side elevational view of an exemplary display device that may be used with the display system shown in FIG. 2.

FIG. 4 is a perspective illustration of exemplary actual and virtual images that may be generated by the display system shown in FIG. 2.

FIG. 5 is a view of an exemplary composite image that may be displayed using the display system shown in FIG. 2.

FIG. 6 is a view of an exemplary virtual image component that may be displayed in the display system shown in FIG. 2.

### DETAILED DESCRIPTION

The exemplary systems and methods described herein overcome at least some disadvantages of known devices and systems that provide information to drivers and other occupants of vehicles. As used herein, the term “vehicle” refers to not only to passenger automobiles, but also to any powered land vehicle used to transport at least one human occupant (i.e., the driver) over a distance, wherein the at least one human occupant actively controls at least one function of the vehicle. As used herein, “forward” refers to a direction toward a front end of vehicle 12, and “rearward” refers to a direction away from the front end of vehicle. More specifically, the embodiments described herein may include a multi-layer interactive display system for use in a vehicle that presents to a driver (or other vehicle occupant) multiple layers of display content that appear separated by a distance from each other. More specifically, in the exemplary embodiment, a driver directly views a first monitor provided by the display system, and views reflected (virtual) images from second and third monitors, are presented so as to appear in separate layers between the driver and the image generated by the first monitor. That is, the image from the first monitor and the virtual images from the second and third monitors are projected to the driver as being present in different viewing planes (or layers).

In the exemplary embodiment, the multi-layered display is a part of an interactive user application associated with a system that controls a function of the vehicle, such as a cruise control system, a navigation system, an entertainment system, and/or a climate control system. A visual feedback device, such as, for example, a moving cursor, corresponding to driver input received via a user input device, is displayed on a first layer of the display. In the exemplary embodiment, the visual feedback is presented in a layer that appears to be physically closer to the driver than other layers of the display. By placing the visual feedback (cursor) on a separate layer that appears closest to the driver, driver awareness of the location of the cursor is facilitated to be heightened. The layers forward of, or “beneath” the visual feedback layer (i.e., appearing to the driver to be farther away than the visual feedback layer) may be associated with any vehicle system or systems, such as basic operational instrumentation, a cruise control system, a navigation system, an entertainment system, and/or a climate control system.

FIG. 1 is a perspective view of an exemplary console area 10 of a vehicle 12. In the exemplary embodiment, console area 10 is positioned forward of a driver's seat (not shown in FIG. 1). As previously mentioned, as used herein, “forward” refers to a direction toward a front end of vehicle 12, and “rearward” refers to a direction away from the front end of vehicle 12. Console area 10 includes a console 14. A steering wheel 16 is mounted to extend rearwardly from console 14, and a display device 18 is coupled to console 14, such that device 18 is visible through, forward of, and to the sides of steering wheel 16. As used herein, the term “couple” is not limited to a direct mechanical, electrical, and/or communication connection between components, but may also include an indirect mechanical, electrical, and/or communication connection between multiple components. Several user input devices 20 are positioned on steering wheel 16. Exemplary user input devices 20 include, but are not limited to only including, a touchpad 22, buttons 24, 26, and 28, a trackball 30, a joystick 32, a motion detection device, and/or any other input devices that facilitate receipt of an input from a user.

FIG. 2 is a simplified schematic illustration of an exemplary vehicle control system 100. The term “vehicle control system” should be understood to include not only systems that regulate basic operational and driving functions of a vehicle, such as a cruise control system, but also to include systems not directly related to driving functions of vehicle 12, such as a navigation system, an entertainment system, and/or a climate control system. Vehicle control system 100 is coupled to one or more input sources 102a, 102b, and 102c. Although three input sources 102a-c are illustrated, embodiments of the present disclosure may have more or fewer input sources, as are needed to enable vehicle control system 100 to function as described herein. Input sources 102a-c may be associated with driving functions of vehicle 12, such as wheel or motor speed sensors, temperature sensors, wheel or drive shaft rotation counters, voltage or amp meters, oxygen sensors or other pollution control devices, and/or any other sensor associated with basic operational functions of vehicle 12. Alternatively, input sources 102a, 102b, 102c may represent inputs received from user input devices 20 such as touchpad 22, buttons 24, 26, and 28, trackball 30, and joystick 32(shown in FIG. 1).

Each input source 102a-102c is coupled to a computer system 104 within control system 100. Computer system 104 may include one or more processors 106 that receive, via connections 103a, 103b, and 103c, each of which may be any suitable medium, whether hard-wired or wireless, signal(s) transmitted from input sources 102a-102c. Processor(s) 106 are coupled to one or more memory devices 108, and in the exemplary embodiment, memory device(s) 108 may store signals transmitted from input sources 102a-102c. Memory device(s) 108 may also store data obtained through processing of signals received from input sources 102a-102c, as required to enable control system 100 to function as described herein and to enable vehicle 12 to operate.

Computer system 104 is coupled to a display system 110 that includes display device 18. Display system 110 may also include one or more processors 112. Processor(s) 112, working alone or in conjunction with computer system 104, use signals received from input device(s) 102a-102c to provide signals to display device 18 that are converted into multi-layered images as described in more detail below.

In the exemplary embodiment, computer system 104 is communicatively coupled to display device 18 located in console 14. Computer system 104 may be physically located in any portion of vehicle 12 that enables computer system 104, vehicle control system 100 and/or display system 110 to function as described herein. To service systems such as, but not limited to, a cruise control system, a navigation system, an emergency distress communications system, or a built-in mobile communication system, computer system 104, in the exemplary embodiment, is coupled to a remote server 120 via a network 122 that enables server 120 to communicate with computer system 104. In the exemplary embodiment, server 120 is a hardware system, such as a computer, that performs various computational tasks for various programs or clients. More specifically, server 120 executes one or more services as a host to serve the needs of the users of computer system 104. For example, in the exemplary embodiment, server 120 may be an application server that runs various software or user-selected applications. Server 120 may also be a database server, a file server, a mail server, a print server, a web server, or any other type of server that enables vehicle control system 100, display system 110, and/or vehicle 12 to function as described herein.

In the exemplary embodiment, network 122 may include, but is not limited to, the Internet, a local area network (LAN), a wide area network (WAN), a wireless LAN (WLAN), a mesh network, and/or a virtual private network (VPN). In the exemplary embodiment, server 120 may communicate with vehicle 12 using a wired network connection (e.g., Ethernet or an optical fiber), a wireless communication means, such as radio frequency (RF), e.g., FM radio and/or digital audio broadcasting, an Institute of Electrical and Electronics Engineers (IEEE®) 802.11 standard (e.g., 802.11(g) or 802.11(n)), the Worldwide Interoperability for Microwave Access (WIMAX®) standard, a cellular phone technology (e.g., the Global Standard for Mobile communication (GSM)), a satellite communication link, and/or any other suitable communication means. (WIMAX is a registered trademark of WiMax Forum, of Beaverton, Oreg. IEEE is a registered trademark of the Institute of Electrical and Electronics Engineers, Inc., of New York, N.Y.)

In the exemplary embodiment, computer system 104 receives signals transmitted from input sources 102a-102c, such as user input devices 20 to enable user inputs to be executed. In some embodiments, executable instructions are stored in memory device 108. As used herein, the term processor is not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein.

Memory device 108 stores information, such as executable instructions and/or other data to be stored and retrieved. Specifically, memory device 108 stores instructions relating to one or more user applications 109 associated with one or more functions of vehicle 12, such as cruise control, navigation, entertainment, and/or climate control. In an exemplary embodiment, user application 109 supports an interactive screen or graphical user interface (“GUI”) that a vehicle occupant (i.e., a driver) can use to operate and/or control one or more functions of vehicle 12, and/or view or change user settings for informational displays, such as a speedometer, a tachometer, a fuel gauge, etc. Memory device 108 may include one or more computer readable media, such as, without limitation, dynamic random access memory (DRAM), static random access memory (SRAM), a solid state disk, and/or a hard disk. Moreover, in the exemplary embodiment, memory device 108 may include random access memory (RAM), which can include non-volatile RAM (NVRAM), magnetic RAM (MRAM), ferroelectric RAM (FeRAM) and other forms of memory.

Memory device 108 may also include read only memory (ROM), flash memory and/or Electrically Erasable Programmable Read Only Memory (EEPROM). Any other suitable magnetic, optical and/or semiconductor memory, by itself or in combination with other forms of memory, may be included in memory device 108. Memory device 108 may also be, or include, a detachable or removable memory, including, but not limited to, a suitable cartridge, disk, CD ROM, DVD or USB memory. Alternatively, memory device 108 may be a database. The term “database” refers generally to any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.

FIG. 3 is a side elevational view of display device 18. In the exemplary embodiment, display device 18 is mounted within console 14 (shown in FIG. 1). Display device 18 includes a housing 200 having a transparent or translucent screen 202 that is oriented to face a driver 204. A first monitor 206 is coupled to a floor 208 of housing 200 such that first monitor 206 is sufficiently far enough from screen 202 to enable driver 204 to directly view first monitor 206 through screen 202. That is, light rays 207 travel a direct path from first monitor 206 to driver 204. Accordingly, an image 234 (illustrated in FIG. 4) created by first monitor 206 resides in the plane of first monitor 206. A second monitor 210 is coupled to floor 208, between first monitor 206 and screen 202, such as, for example, forward of a wall 212, such that second monitor 210 is not directly viewable through screen 202 by driver 204. A third monitor 214 is coupled to an upper wall 216 of housing 200, and is likewise positioned out of a direct line-of-sight through screen 202 to driver 204.

A first combiner 218 is mounted within housing 200. First combiner 218 is a partially transparent and partially reflective structure that enables light rays 219 emitted from second monitor 210 to reflect off a front surface 220 of first combiner 218 and be directed through screen 202 towards driver 204. However, light rays striking a rear surface 222 of first combiner 218, such as light rays 207 emitted by first monitor 206, pass through first combiner 218 undeflected. Light rays 219, when reflected, create a virtual image 224 that appears to driver 204 to be physically located between driver 204 and an image appearing in first monitor 206. Such “two-way” mirror-type structures are known, and first combiner 218 may be fabricated using any suitable materials and/or techniques that enable first combiner 218 and display device 18 to function as described herein.

Similarly, a second combiner 226 is mounted within housing 200, and is a partially reflective and partially transparent or translucent structure. Light rays 227 emitted from third monitor 214 strike an upper surface 228 of second combiner 226 and are reflected towards driver 204, while light rays 207 striking a lower surface 230 of second combiner 226 pass through second combiner 226 undeflected. Light rays 227, when reflected, create a virtual image 232, that appears to driver 204 to be substantially parallel to virtual image 224, but farther from driver 204 than virtual image 224. Virtual image 232 also appears to be obliquely oriented with respect to an image 234 (illustrated in FIG. 4) displayed in first monitor 206. In the exemplary embodiment, image 232 also intersects image 234.

FIG. 4 is a perspective illustration of exemplary virtual images 224 and 232, and an exemplary actual image 234 that may be generated by display system 110 (shown in FIG. 2). FIG. 5 is a plan view of an exemplary composite image 240 that may be formed from the overlay of virtual images 224 and 232, and actual image 234, as observed by driver 204 (shown in FIG. 3). In an exemplary embodiment, virtual images 232 and 234 are generated by application 109 (shown in FIG. 2) as part of a navigation system. Specifically, composite image 240 represents an interactive screen or graphical user interface (“GUI”) (illustrated in FIG. 5) for selection of a destination city, and includes a horizontally-scrollable alphabet bar 236 (shown in FIG. 4). A numeric/character bar (not shown) that includes Arabic numerals, mathematical symbols, or other non-alphabetical characters may be positioned above or below alphabet bar 236, such that a user may scroll upwardly or downwardly to select the numeric/character bar, and then scroll horizontally to select a numeral or character. Image 234 may also include a vertically-scrollable listing 238 of cities (illustrated in FIG. 5). Virtual image 232, in the exemplary embodiment, includes a focus window 242 surrounded by direction arrows 244. To enable driver 204 to interact with application 109, display system 110 causes a virtual cursor 246 to be displayed in virtual image 224.

Cursor 246 moves in response to input by driver 204, for example, via touchpad 22 (shown in FIG. 1). Cursor 246 appears, to driver 204, to reside in a plane 225 that is spaced apart from and closer to the driver 204 than a plane 233 in which virtual image 232 appears. Furthermore, in the exemplary embodiment, plane 235 is obliquely oriented to and, at least in part, appears to the driver 204 to be closer than a plane 237 in which image 234 appears. Accordingly, cursor 246 can be moved, via touchpad 22, for example, so as to appear to in superposition relative to one or more graphical elements displayed in either of images 232 and 234. Once cursor 246 has been positioned in a desired location by driver 204, driver 204 may input a selection corresponding to the desired location, via one of user input devices 20, to make a selection or cause some other action to occur, depending on the nature of application 109 (shown in FIG. 2), and user configurations of user input devices 20.

In the exemplary embodiment, as cursor 246 moves in response to driver input, display system 110 causes second monitor 210 to create a trail 248, for example, of faded and/or reduced-size versions of cursor 246, as feedback to driver 204. As such, the awareness of driver 204 to the relative location and movement of cursor 246 is facilitated to be heightened. Although illustrated as circular-shaped, cursor 246 may be arrow-shaped, finger-shaped, and/or any other shape that allows display system 110 to function as described. In the exemplary embodiment, computer system 104 and/or processor 112 cause actual image 234 and virtual image 232 to interact with and to respond to cursor 246 of virtual image 224. In alternative embodiments, a greater or lesser number of images may be provided for interaction with cursor 246. In addition, depending upon the nature of the application, cursor 246 (through user input devices 20) may interact with any of the other images presented by display device 18.

In addition, in the exemplary embodiment, system 110 may be configured such that cursor 246 of virtual image 224 may be used with a variety of image types and applications, and such that cursor 246 may be used to toggle between different GUIs directed to different functions of vehicle 12. For example, FIG. 6 illustrates a composite screen 250 that includes a speedometer display 252 that may be generated by first monitor 206 (shown in FIG. 3) as image 234. Superimposed over speedometer display 252 is a radio station selector display 254 (for example, displaying a frequency of 79.9 kHz). Accordingly, radio station selector display 254 may be generated by third monitor 214 as virtual image 232 (shown in FIG. 3). Cursor 246 is superimposed over both speedometer display 252 and radio station selector display 254. In an embodiment, after driver 204 has positioned cursor 246 over radio station selector display 254, driver 204 can, for example, “click” on the displayed frequency and, using one or more of input devices 20, raise or lower the displayed frequency to change radio stations.

As compared to known devices and systems that provide multi-layered displays to users of vehicles, the embodiments described herein include an interactive display system that provides feedback to a vehicle user in response to input provided by the vehicle user. Moreover, the embodiments described herein include a virtual image that is located in a plane that is different than a plane in which another image appears, wherein the virtual image includes a cursor that is movable via input received from a user, for example, relative to portions of the underlying image to enable the user to interact with the underlying image. More specifically, the embodiments described herein include an image of a cursor that appears to be closer to the driver than the other images in the display, such that the driver's awareness of the location of the cursor is facilitated to be heightened. Furthermore, the embodiments described herein include a cursor image that interacts with images corresponding to a plurality of functional systems of a vehicle, such as a cruise control system, a navigation system, an entertainment system, and/or a climate control system. In addition, the embodiments described herein include an image of a movement trail of a cursor, such that the driver's awareness of the path of movement of the cursor is enhanced.

A technical effect of the systems, apparatus, and methods described herein includes at least one of the following steps, such as: (a) presenting a first image to a vehicle occupant, using a first image source communicatively coupled to a vehicle, wherein the first image includes at least one graphical element; (b) presenting a second image to the vehicle occupant, using a second image source communicatively coupled to the vehicle, wherein the second image appears to be positioned between the first image and the vehicle occupant, and wherein the second image includes a cursor image responsive to input received from the vehicle occupant via at least one user input device coupled to the at least one processor, and wherein the first and second images together comprise a graphical user interface (GUI) associated with a user application controlling a function of the vehicle; (c) receiving input from the vehicle occupant via the at least one user input device such that the vehicle occupant can interact with the at least one graphical element (d) receiving input causing the processor to superimpose the cursor over the at least one graphical element and initiate an action relative to the at least one graphical element; and (e) presenting a third image that appears to the vehicle occupant to be positioned behind the second image, using a third image source communicatively coupled to the vehicle.

Exemplary embodiments of systems, apparatus, and methods for providing a multi-layered display in vehicles are described above in detail. The systems, apparatus, and methods are not limited to the specific embodiments described herein, but rather, components of each system, apparatus, and/or steps of each method may be utilized independently and separately from other components and/or steps described herein. For example, each system may also be used in combination with other systems and methods, and is not limited to practice only with systems as described herein. Rather, the exemplary embodiment can be implemented and utilized in connection with many other applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples for the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An interactive display system for use in a vehicle, said system comprising:
a computer system comprising at least one processor coupled to a memory device;
a first image source communicatively coupled to said computer system, said first image source coupleable to the vehicle for presenting a first image to a vehicle occupant;
a second image source communicatively coupled to said computer system, said second image source coupleable to the vehicle for presenting a second image that appears to be positioned between the first image and the vehicle occupant, wherein the first and second images together comprise a graphical user interface (GUI) associated with a user application controlling a function of the vehicle; and
at least one user input device coupled to said at least one processor;
wherein said memory device stores computer-executable instructions that, when executed by said at least one processor cause said at least one processor to:
cause said first image source to generate a first image comprising at least one graphical element associated with the graphical user interface (GUI), the at least one graphical element responsive to input from the vehicle occupant; and
cause said second image source to generate a second image comprising a cursor image responsive to input from the vehicle occupant via said at least one user input device, such that the vehicle occupant can interact with the at least one graphical element.

2. The interactive display system in accordance with claim 1, wherein the processor is programmed to cause said second image source to superimpose the cursor image over the at least one graphical element and initiate an action relative to the at least one graphical element via said at least one user input device.

3. An interactive display system in accordance with claim 1, wherein said first image source comprises a first monitor oriented for displaying the first image for direct viewing by the vehicle occupant.

4. An interactive display system in accordance with claim 3, wherein said second image source comprises:
a second monitor for displaying the second image thereon; and
a first combiner oriented with respect to said first and second image sources for positioning a reflection of the cursor image on a plane that appears to the vehicle occupant to be superimposed over the first image.

5. An interactive display system in accordance with claim 4, further comprising a third image source coupleable to the vehicle for presenting a third image that appears to the vehicle occupant to be positioned behind the second image, wherein said third image source comprises:
a third monitor for displaying the third image thereon; and
a second combiner oriented with respect to said first and third image sources for positioning a reflection of the third image over at least a portion of the first image, and wherein the cursor image is positionable over elements of the third image.

6. An interactive display system in accordance with claim 5, wherein said second combiner is positioned so as to cause the third image to be obliquely oriented with respect to the first image.

7. An interactive display system in accordance with claim 1, wherein said at least one user input device comprises at least one of a touchpad, a button, a trackball, a joystick, and a motion detection device.

8. A vehicle comprising:
a console; and
a computer system coupleable to said console and including at least one processor coupled to a memory device;
a first image source communicatively coupled to said computer system for presenting a first image to a vehicle occupant;
a second image source communicatively coupled to said computer system for presenting a second image that appears to be positioned between the first image and the vehicle occupant; and
at least one user input device coupled to said at least one processor;
wherein said memory device stores computer-executable instructions that, when executed by said at least one processor cause said at least one processor to:
cause said first image source to generate a first image associated with an function of the vehicle that is responsive to input by the vehicle occupant; and
cause said second image source to generate a cursor image responsive to input from the vehicle occupant via said at least one user input device, such that the vehicle occupant can interact with the at least one graphical element.

9. A vehicle in accordance with claim 8, wherein said processor is programmed to cause said second image source to superimpose the cursor image over the at least one graphical element and initiate an action relative to the at least one graphical element via said at least one user input device.

10. A vehicle in accordance with claim 8, wherein said first image source comprises a first monitor oriented for displaying the first image for direct viewing by the vehicle occupant.

11. A vehicle in accordance with claim 10, wherein said second image source comprises:
a second monitor for displaying the second image thereon; and
a first combiner oriented with respect to said first and second image sources for positioning a reflection of the cursor image on a plane that appears to the vehicle occupant to be over the first image.

12. A vehicle in accordance with claim 11, further comprising a third image source coupleable to the vehicle console for presenting a third image that appears to the vehicle occupant to be positioned behind the second image, wherein said third image source comprises:
a third monitor for displaying the third image thereon; and
a second combiner oriented with respect to said first and third image sources for positioning a reflection of the third image over at least a portion of the first image, and wherein the cursor image is positionable over elements of the third image.

13. A vehicle in accordance with claim 12, wherein said second combiner is positioned so as to cause the third image to be obliquely oriented with respect to the first image.

14. A vehicle in accordance with claim 8, wherein said at least one user input device comprises at least one of a touchpad, a button, a trackball, a joystick, and a motion detection device.

15. A method for presenting an interactive display in a vehicle, said method implemented using a computer system including at least one processor coupled to a memory device, said method comprising:
presenting a first image to a vehicle occupant, using a first image source communicatively coupled to a vehicle, the first image comprising at least one graphical element;
presenting a second image to the vehicle occupant, using a second image source communicatively coupled to the vehicle, wherein the second image appears to be positioned between the first image and the vehicle occupant, the second image comprising a cursor image responsive to input received from the vehicle occupant via at least one user input device coupled to the at least one processor, and wherein the first and second images together comprise a graphical user interface (GUI) associated with a user application controlling a function of the vehicle; and
receiving input from the vehicle occupant via the at least one user input device such that the vehicle occupant can interact with the at least one graphical element.

16. A method in accordance with claim 15, wherein receiving input from the vehicle occupant comprises receiving input causing the processor to superimpose the cursor over the at least one graphical element and initiate an action relative to the at least one graphical element.

17. A method in accordance with claim 15, wherein presenting a first image to a vehicle occupant comprises coupling a first monitor to the vehicle for displaying the first image for direct viewing by the vehicle occupant.

18. A method in accordance with claim 15, wherein presenting a second image to the vehicle occupant comprises:
coupling a second monitor to the vehicle for displaying the second image thereon; and
orienting a first combiner within the vehicle with respect to the first and second image sources for positioning a reflection of the cursor image on a plane that appears to the vehicle occupant to be over the first image.

19. A method in accordance with claim 15, further comprising presenting a third image that appears to the vehicle occupant to be positioned behind the second image, using a third image source communicatively coupled to the vehicle, wherein presenting a third image to a vehicle occupant comprises:
coupling a third monitor to the vehicle for displaying the third image thereon; and
orienting a second combiner within the vehicle with respect to the first and third image sources for positioning a reflection of the third image over at least a portion of the first image, and wherein the cursor image is positionable over elements of the third image.

20. A method in accordance with claim 15, wherein receiving input from the vehicle occupant via at least one user input device comprises receiving input via at least one of a touchpad, a button, a trackball, a joystick, and a motion detection device.
